(19) United States
(12) Patent Application Publication
(10) Pub. No.: US 2013/0208168 A1
(43) Pub. Date: Aug. 15, 2013

(54) DIGITAL PHOTOGRAPHING APPARATUS AND CONTROL METHOD THEREOF

(71) Applicants: Kyoung-ae Kim, Suwon-si (KR); Hye-ryoung Seo, Seoul (KR)

(72) Inventors: Kyoung-ae Kim, Suwon-si (KR); Hye-ryoung Seo, Seoul (KR)

(73) Assignee: Samsung Electronics Co., Ltd., Suwon-si (KR)

(21) Appl. No.: 13/605,045

(22) Filed: Sep. 6, 2012

(30) Foreign Application Priority Data
Feb. 10, 2012 (KR) 10-2012-0013805

(51) Int. Cl. H04N 5/262

(52) U.S. Cl. 348/333.12; 348/E05.055

(57) ABSTRACT

A digital photographing apparatus and a control method thereof is provided for generating and displaying a first image from image data in a first area of an image pickup device and generating and displaying a second image from image data in a second area, which includes the first area and an area except for the first area of the image pickup device, in response to a zoom-out signal. Accordingly, realizing a zoom-out function using an image area projected to an image pickup device may allow a user to capture images at various angles of view, thereby increasing user satisfaction when capturing an image.

### CROSS-REFERENCE TO RELATED PATENT APPLICATION

This application claims the priority benefit of Korean Patent Application No. 10-2012-0013805, filed on Feb. 10, 2012, in the Korean Intellectual Property Office, the disclosure of which is incorporated herein in its entirety by reference.

### BACKGROUND

Various embodiments relate to a digital photographing apparatus and a control method thereof.

Digital photographing apparatuses may have a zoom function. The zoom function may include a wide-angle zoom function and a telephoto zoom function. The wide-angle zoom function may allow an angle of view to be wide and a selected exposure area for display to increase. The telephoto zoom function may allow the angle of view to be narrow and the selected exposure area to decrease.

In addition, there are various types of lenses largely classified into fisheye lenses (an angle of view of more than 180°), wide-angle lenses (an angle of view of 60° to 80°), standard lenses (an angle of view of 40° to 60°), and telephoto lenses (an angle of view of less than 40°.

Conventionally, when an image is captured, a live view image is captured regardless of the types of lenses by basically using the entire area of an image pickup device and setting a maximum angle of view of a lens as a default. In image capturing, zoom-in of the live view image is possible while zoom-out thereof is impossible.

### SUMMARY

Various embodiments provide a digital photographing apparatus capable of capturing images at various angles of view by realizing a zoom-out function using an image area projected to an image pickup device and a control method thereof.

According to an embodiment, there is provided a method of controlling a digital photographing apparatus, the method including: generating and displaying a first image from image data in a first area of an image pickup device; and generating and displaying a second image from image data in a second area, which includes the first area and an area except for the first area of the image pickup device, in response to a zoom-out signal.

The method may further include generating a capture image by capturing the second image in response to a capture signal.

The method may further include generating a capture image by capturing the first image in response to a capture signal, after the generating and displaying of the first image.

The generating and displaying of the first image may include generating and displaying a plurality of first images from image data of a plurality of areas divided from the first area of the image pickup device or generating and displaying a single first image by combining the plurality of areas.

The method may further include generating at least one of first capture images obtained by capturing the plurality of divided areas and a second capture image obtained by capturing a single area obtained by combining the plurality of divided areas in response to a capture signal, after the generating and displaying of the first image.

The generating and displaying of the second image may include adjusting a size of the second area in response to the zoom-out signal.

The generating and displaying of the second image may include generating and displaying the second image in response to a first image touch signal.

The generating and displaying of the second image may include adjusting the size of the second area in response to the first image touch signal.

The generating and displaying of the first image may include generating and displaying a first image in which a face is included in the image data in the first area of the image pickup device.

According to another embodiment, there is provided a method of controlling a digital photographing apparatus, the method including: receiving a picked-up image from an image pickup device; generating and displaying a first image from image data in a first area of the received picked-up image; and generating and displaying a second image from image data in a second area, which includes the first area and an area except for the first area of the received picked-up image, in response to a zoom-out signal.

The method may further include generating a capture image by capturing the second image in response to a capture signal.

The method may further include generating a capture image by capturing the first image in response to a capture signal, after the generating and displaying of the first image.

The generating and displaying of the first image may include generating and displaying a plurality of first images from image data of a plurality of areas divided from the first area of the image pickup device or generating and displaying a single first image by combining the plurality of areas.

The method may further include generating at least one of first capture images obtained by capturing the plurality of divided areas and a second capture image obtained by capturing a single area obtained by combining the plurality of divided areas in response to a capture signal, after the generating and displaying of the first image.

The generating and displaying of the second image may include adjusting a size of the second area in response to the zoom-out signal.

The generating and displaying of the second image may include generating and displaying the second image in response to a first image touch signal.

The generating and displaying of the second image may include adjusting the size of the second area in response to the first image touch signal.

The generating and displaying of the first image may include generating and displaying a first image in which a face is included in the image data in the first area of the image pickup device.

According to another embodiment, there is provided a digital photographing apparatus including: a first receiver that receives image data of a first area of an image pickup device; a second receiver that receives image data in a second area that includes the first area and an area except for the first area of the image pickup device; and a controller that generates and displays a first image from the image data in the first area, which is received from the first receiver, and generates and displays a second image from the image data in the second area, which is received from the second receiver, in response to a zoom-out signal.

According to another embodiment, there is provided a digital photographing apparatus including: a receiver that receives a picked-up image from an image pickup device; and a controller that generates and displays a first image from image data in a first area of the received picked-up image and generates and displays a second image from image data in a second area, which includes the first area and an area except for the first area of the received picked-up image, in response to a zoom-out signal.

### BRIEF DESCRIPTION OF THE DRAWINGS

The above and other features and advantages of the invention will become more apparent by describing in detail exemplary embodiments thereof with reference to the attached drawings in which:

FIG. 1 is a block diagram of a digital photographing apparatus, according to an embodiment;

FIG. 2 is a detailed block diagram of a digital signal processor in the digital photographing apparatus of FIG. 1, according to an embodiment;

FIGS. 3A, 3B, and 3C are images displayed when a zoom-out function is performed by the digital signal processor of FIG. 2;

FIG. 4A illustrates a conventional zoom adjustment bar;

FIG. 4B illustrates a zoom adjustment bar provided to realize a zoom function in the digital photographing apparatus of FIG. 1;

FIG. 5 illustrates a setup menu provided to realize the zoom-out function in the digital photographing apparatus of FIG. 1;

FIGS. 6A, 6B, and 6C are images displayed when the zoom-out function is performed based on the setup menu of FIG. 5;

FIGS. 7A and 7B illustrate an example of realizing the zoom-out function using a screen touch in the digital photographing apparatus of FIG. 1;

FIGS. 8A, 8B, 8C, and 8D are images displayed when the zoom-out function is performed by the digital signal processor of FIG. 2;

FIG. 9 is a detailed block diagram of the digital signal processor, according to another embodiment;

FIGS. 10A, 10B, and 10C are images displayed when the zoom-out function is performed by the digital signal processor of FIG. 9;

FIG. 11 is a flowchart illustrating a method of controlling the digital photographing apparatus, according to an embodiment; and

FIG. 12 is a flowchart illustrating a method of controlling the digital photographing apparatus, according to another embodiment.

### DETAILED DESCRIPTION

Various embodiments may allow various kinds of change or modification and various changes in form, and specific embodiments will be illustrated in the drawings and described in detail in the specification. However, it should be understood that the specific embodiments do not limit the invention to a specific disclosing form but include every modified, equivalent, or replaced one within the spirit and technical scope of the invention. In the following description, well-known functions or constructions are not described in detail since they would obscure the invention with unnecessary detail.

Although terms, such as “first” and “second”, can be used to describe various elements, the elements cannot be limited by the terms. The terms can be used to classify a certain element from another element.

The terminology used in the application is used only to describe specific embodiments and does not have any intention to limit the invention. An expression in the singular includes an expression in the plural unless they are clearly different from each other in context. In the application, it should be understood that terms, such as “include” and “have”, are used to indicate the existence of implemented feature, number, step, operation, element, part, or a combination of them without excluding in advance the possibility of existence or addition of one or more other features, numbers, steps, operations, elements, parts, or combinations of them.

The invention will now be described more fully with reference to the accompanying drawings, in which exemplary embodiments of the invention are shown. Like reference numerals in the drawings denote like elements, and thus their repetitive description will be omitted.

Expressions such as “at least one of,” when preceding a list of elements, modify the entire list of elements and do not modify the individual elements of the list.

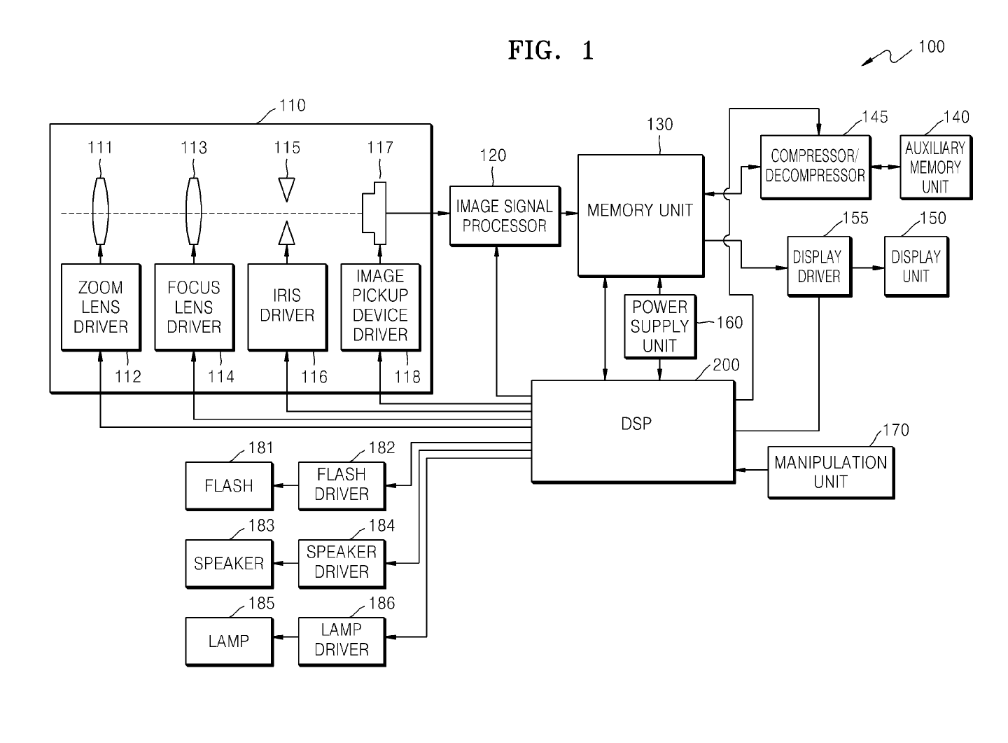

FIG. 1 is a block diagram of a digital camera 100 as a digital photographing apparatus, according to an embodiment. However, the digital photographing apparatus is not limited to the digital camera 100 shown in FIG. 1 and may also be applied to various digital devices such as digital single-lens reflex (DSLR) cameras and hybrid cameras. A configuration of the digital camera 100 shown in FIG. 1 will now be described along with an operation thereof.

First, a process of capturing a subject is described. Luminous flux from the subject transmits through a zoom lens 111 and a focus lens 113 in an optical system of an image pickup unit 110, the intensity of radiation is adjusted depending on an open/close degree of an iris 115, and an image of the subject is picked up on a light-reception face of an image pickup device 117. The image picked up on the light-reception face of the image pickup device 117 is converted to an electrical image signal by a photoelectric conversion process.

The image pickup device 117 may include a Charge-Coupled Device (CCD) or a Complementary Metal-Oxide Semiconductor (CMOS) image sensor for converting an optical signal to an electric signal. The image pickup device 117 as a CMOS image sensor has a strong point in maintaining electric power of the digital camera 100 using a battery because of low power consumption required for capturing. Thus it is advantageous in making an area of the image pickup device 117 large because of a relatively cheap manufacturing cost per unit, and the image pickup device 117 can be mass produced easily. Since the image pickup device 117 as a CCD has much less noise generation and a faster image information transmission speed than the CMOS image sensor, the image pickup device 117 as a CCD has advantages that a storing speed in continuous capturing is fast and image quality is excellent.

The iris 115 may be in an open state under normal conditions or when an auto-focusing algorithm performed by receiving a first release signal generated by half pressing a release button is executed. The iris 115 may also allow an exposure process to be performed by receiving a second release signal generated by full pressing the release button.

Positions of the zoom lens 111 and the focus lens 113 are controlled by a zoom lens driver 112 and a focus lens driver 114, respectively. For example, if a wide-angle zoom (zoom-out) signal is generated, a focal length of the zoom lens 111 is shortened to make an angle of view wide, and if a telephoto zoom (zoom-in) signal is generated, the focal length of the zoom lens 111 is lengthened to make the angle of view narrow. Since the position of the focus lens 113 is adjusted in a state where the position of the zoom lens 111 is set, the angle of view is hardly affected by the position of the focus lens 113. An open degree of the iris 115 is controlled by an iris driver 116. Sensitivity of the image pickup device 117 is controlled by an image pickup device controller 118.

The zoom lens driver 112, the focus lens driver 114, the iris driver 116, and the image pickup device controller 118 control respective components according to a result calculated in a Digital Signal Processor (DSP) 200 based on exposure information and focus information.

Next, an image signal generation process is described. An image signal output from the image pickup device 117 is input to an image signal processor 120. If the image signal input from the image pickup device 117 is an analog signal, the image signal processor 120 converts the analog signal to a digital signal, and various image processes are performed on the digital image signal. The processed image signal is temporarily stored in a memory unit 130.

In detail, the image signal processor 120 improves image quality by performing image processing, such as Auto White Balance (AWB), Auto Exposure (AE), and gamma correction, to transform image data so as to meet the human sense of sight and outputs an image signal of improved image quality. In addition, the image signal processor 120 performs image processing, such as color filter array interpolation, color matrix, color correction, and color enhancement.

The memory unit 130 may include a program memory unit that stores a program associated with an operation of the digital camera 100 regardless of whether power is supplied and a main memory unit that temporarily stores the image data and other data while power is being supplied.

The program memory unit stores an Operating System (OS) and various application programs for operating the digital camera 100. The DSP 200 controls components of the digital camera 100 according to the programs stored in the program memory unit. According to an embodiment, if a motion area is set in at least two continuous images, a program for displaying the images as slides by the set motion area may be stored in the program memory unit and executed under control of the DSP 200.

The main memory unit stores image signals output from the image signal processor 120 or an auxiliary memory unit 140.

A power supply unit 160 may be directly connected to the main memory unit regardless of whether power is supplied to operate the digital camera 100. Thus, codes stored in the program memory unit may be copied to the main memory unit and changed to executable codes to quickly boot the digital camera 100, and when the digital camera 100 is rebooted, data stored in the main memory unit may be quickly read.

An image signal stored in the main memory unit is output to a display driver 155 to be converted to an analog signal and simultaneously converted to an image signal in an optimal form to be displayed. The image signal may be displayed on a display unit 150 to be viewed as a predetermined image to a user. The display unit 150 also acts as a view finder for determining a capturing range by continuously displaying image signals acquired by the image pickup device 117 during a capturing mode. Various display devices, such as a Liquid Crystal Display (LCD), an Organic Light-Emitted Diode (OLED) panel, and an Electrophoresis Display Device (EDD) may be used as the display unit 150. Furthermore, the display unit 150 may include a touch screen to input a user operation signal by a touch together with a manipulation unit 170.

A process of recording the generated image signal is described. The image signal is temporarily stored in the memory unit 130, and at this time, various kinds of information regarding the image signal in addition to the image signal are stored in the auxiliary memory unit 140. The stored image signal and information are output to a compressor/decompressor 145. The compressor/decompressor 145 forms an image file by performing a compression process in an optimal storing format with a compression circuit, i.e., performing an encoding process in a format such as Joint Photographic Experts Group (JPEG), and the image file is stored in the auxiliary memory unit 140.

As the auxiliary memory unit 140, various recording media, such as a fixed-type semiconductor memory such as an external flash memory, a semiconductor memory such as a card-type flash memory freely detachable to a device and having a card or stick shape, and magnetic recording media such as a hard disk and a floppy disk, may be used.

A process of reproducing an image is described. The image file compressed and stored in the auxiliary memory unit 140 is output to the compressor/decompressor 145 and decompressed, i.e., decoded, by a decompression circuit to extract an image signal from the image file. The image signal is output to the memory unit 130. The image signal is temporarily stored in the memory unit 130 and may be reproduced as a corresponding image on the display unit 150 by the display driver 155.

The digital camera 100 includes the manipulation unit 170 for receiving an external signal from the user. The manipulation unit 170 includes a shutter release button opening and closing to expose the image pickup device 117 to light for a predetermined time, a power button for supplying power, a zoom-out button and a zoom-in button for widening and narrowing an angle of view according to an input, respectively, and various function buttons, such as character input buttons and direction keys for selecting modes such as a capturing mode and a reproduction mode and selecting a white balance setup function and an exposure setup function.

The digital camera 100 also includes a flash 181 and a flash driver 182 for driving the flash 181. The flash 181 is a light emission device for brightening a subject by instantaneously emitting a bright light on the subject when the subject is photographed in a dark place.

A speaker 183 and a lamp 185 may perform a function of informing of an operation state of the digital camera 100 by outputting a sound signal and a light signal, respectively. In particular, when photographing conditions at a photographing time are different from photographing conditions at a time when the user set photographing variables in a manual mode, a notice signal for informing of this difference may be realized by an alarm sound or a light signal with the speaker 183 or the lamp 185, respectively. The speaker 183 may be controlled by a speaker driver 184 in regards to a sound type and magnitude, and the lamp 185 may be controlled by a lamp driver 186 in regards to light emission/non-emission, a light emission time, and a light emission type.

The DSP 200 performs a computation process according to the OS and application programs stored in the memory unit 130, temporarily stores the computation result, and controls corresponding components of the digital camera 100 according to the computation result to operate the digital camera 100. In particular, the DSP 200 displays an image received from the image pickup device 117 by image processing the image and also displays another image besides an image displayed by a zoom-out signal to allow the user to capture the image.

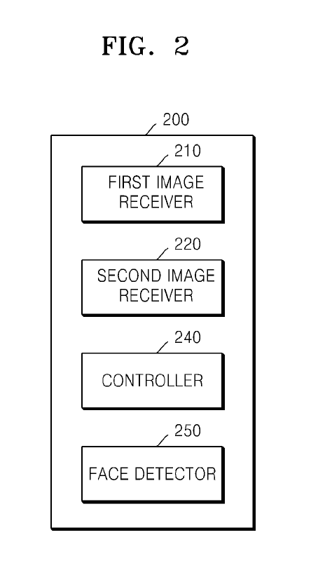

The DSP 200 is described in detail below with reference to FIGS. 2 to 10.

FIG. 2 is a detailed block diagram of the DSP 200 in the digital camera 100 of FIG. 1, according to an embodiment. Referring to FIG. 2, the DSP 200 includes a first image receiver 210, a second image receiver 220, a controller 240, and a face detector 250.

The first image receiver 210 receives image data projected to a first area of the image pickup device 117. The first area of the image pickup device 117 indicates a valid pixel area capable of displaying the image data projected to the image pickup device 117 in a state where a maximum angle of view of a lens is set as a default when the digital camera 100 is turned on. In general, the image data in the first area may be a live view image or a preview image, i.e., an image to be captured, generally displayed on the display unit 150 for image capturing.

The second image receiver 220 receives image data projected to a second area including the first area and an area except for the first area. The second area of the image pickup device 117 indicates an image data area including the valid pixel area displayed on the display unit 150 and an area not displayed on the display unit 150 but projected to the image pickup device 117.

The controller 240 generates a first image from the image data in the first area received from the first image receiver 210 and displays the first image on the display unit 150. Thereafter, the controller 240 generates a second image from the image data in the second area including the first area and an area except for the first area in response to a zoom-out signal input by the user and displays the second image on the display unit 150.

Thereafter, if a capture signal is input by the user, the controller 240 captures the second image to generate a capture image. Alternatively, when the capture signal is input by the user, the controller 240 may capture the first image to generate the capture image.

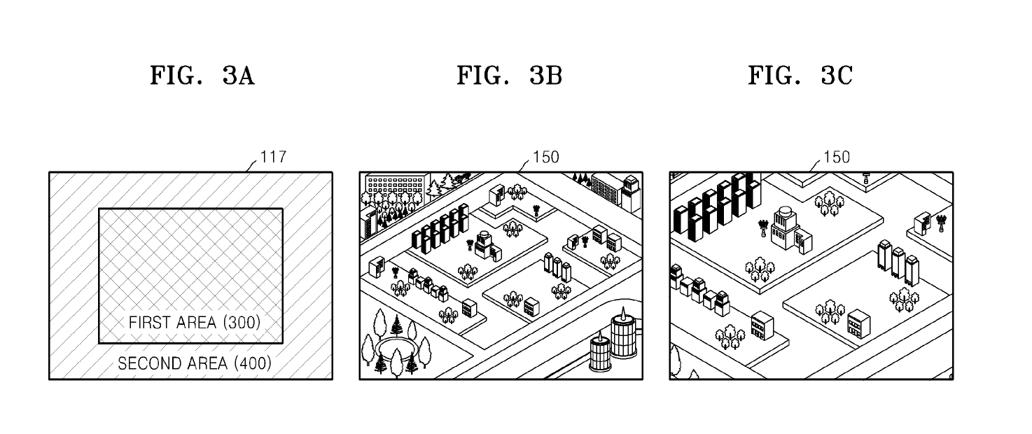

FIGS. 3A, 3B, and 3C are images displayed when a zoom-out function is performed by the DSP 200 of FIG. 2. Referring to FIGS. 3A, 3B, and 3C, FIG. 3A shows a first area 300 of the image pickup device 117 and a second area 400 including the first area 300. FIG. 3B shows an example in which an image projected to the second area 400 of the image pickup device 117 is displayed on the display unit 150, and FIG. 3C shows an example in which an image projected to the first area 300 of the image pickup device 117 is displayed on the display unit 150.

The controller 240 may generate a capture image of the first area 300 or the second area 400 in response to a capture signal input by the user.

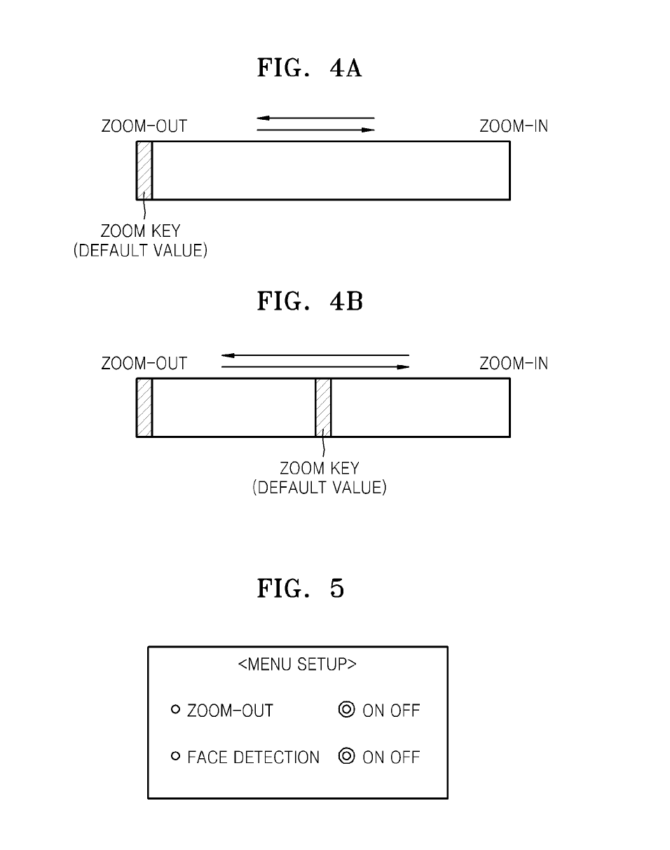

The controller 240 provides a zoom adjustment bar or a setup menu so that the user can selectively view the image data in the first area 300 or the second area 400, as shown in FIGS. 4A to 5.

Referring to FIGS. 4A and 4B, the controller 240 provides the zoom adjustment bar so that the user can selectively view the image data in the first area 300 or the second area 400. When the zoom adjustment bar is displayed on the display unit 150 by a user setup, zoom adjustment may be performed through the zoom-out or zoom-in button or a touch input.

FIG. 4A shows a conventional zoom adjustment bar. Referring to FIG. 4A, the first area 300 of the image pickup device 117 is used, and a default zoom key with a maximum angle of view is shown. In FIG. 4A, an image displayed on the display unit 150 can be zoomed-in using a zoom key. However, the image cannot be zoomed-out.

FIG. 4B shows a zoom adjustment bar, according to an embodiment. Referring to FIG. 4B, the first area 300 and the second area 400 of the image pickup device 117 are used, and a default zoom key with a maximum angle of view is shown. In FIG. 4B, an image displayed on the display unit 150 can be zoomed-in and zoomed-out using a zoom key. When zoom-out is performed using the zoom key, an image in the second area 400 is displayed on the display unit 150, and a size of the image in the second area 400 may be adjusted according to a zoom-out time. FIG. 3B shows an example in which image data in the second area 400 is displayed on the display unit 150 by performing zoom-out with the zoom key.

Referring to FIG. 5, the controller 240 provides the setup menu so that the user can selectively view an image in the first area 300 or the second area 400.

When zoom-out is set on the setup menu shown in FIG. 5, the controller 240 controls the second image receiver 220 to display the second image on the display unit 150 by using the image data in the second area 400. In this case, a current state can be switched to a default state or a zoom-in state using the zoom key.

When face detection is set on the setup menu shown in FIG. 5, the controller 240 controls the face detector 250 to perform face detection on an image and displays an image in the first area 300 including the detected face on the display unit 150.

If zoom-out is also set on the setup menu, the controller 240 displays an image in the second area 400 including the first area 300 in which the detected face is included on the display unit 150. In this case, a current state can be switched to the default state or the zoom-in state using the zoom key.

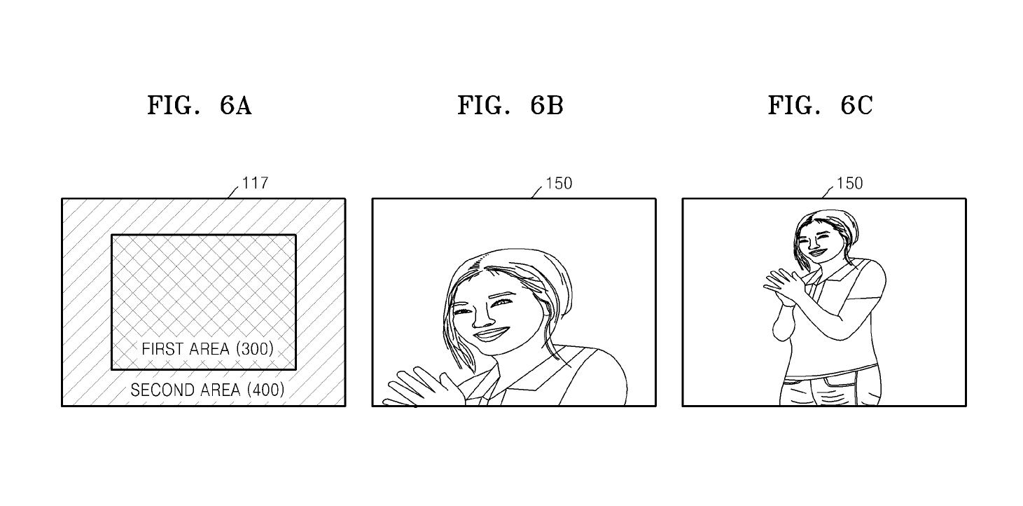

FIGS. 6A, 6B, and 6C are images displayed on the display unit 150 when face detection is set on the setup menu. FIG. 6B shows an example in which an image in the first area 300 including a face is displayed on the display unit 150 by the image pickup device 117 shown in FIG. 6A. FIG. 6C shows an example in which the controller 240 displays an image in the second area 400 including the first area 300 including a face on the display unit 150 when zoom-out and face detection are set on the setup menu. In this case, a current state can be switched to the default state or the zoom-in state using the zoom key.

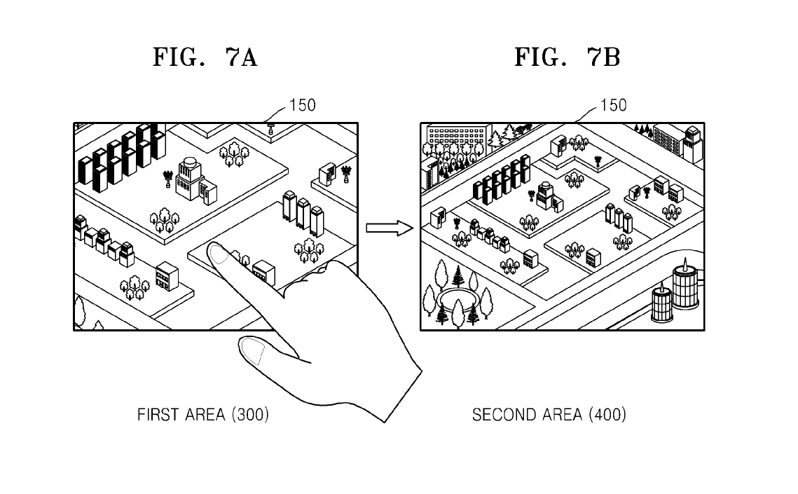

FIGS. 7A and 7B illustrate an example of realizing the zoom-out function using a touch on the display unit 150. Referring to FIGS. 7A and 7B, the controller 240 may receive a touch input for image data in the first area 300 currently displayed on the display unit 150, as shown in FIG. 7A and may display image data in the second area 400 on the display unit 150, as shown in FIG. 7B. In this case, the controller 240 may adjust a size of the second area 400 by receiving a size adjustment touch input by the user. In addition, the controller 240 may switch to the default state or the zoom-in state by receiving a touch input signal corresponding to the zoom key or a zoom key input signal.

According to another embodiment, the controller 240 may generate a plurality of division images from a plurality of areas divided from the first area 300 of the image pickup device 117, which corresponds to the image data received from the first image receiver 210, and display the plurality of division images on the display unit 150. When a capture input signal is received, the controller 240 may capture the plurality of divided areas or a single area obtained by combining the plurality of divided areas or may capture a second image including even image data outside a first image corresponding to the plurality of division images.

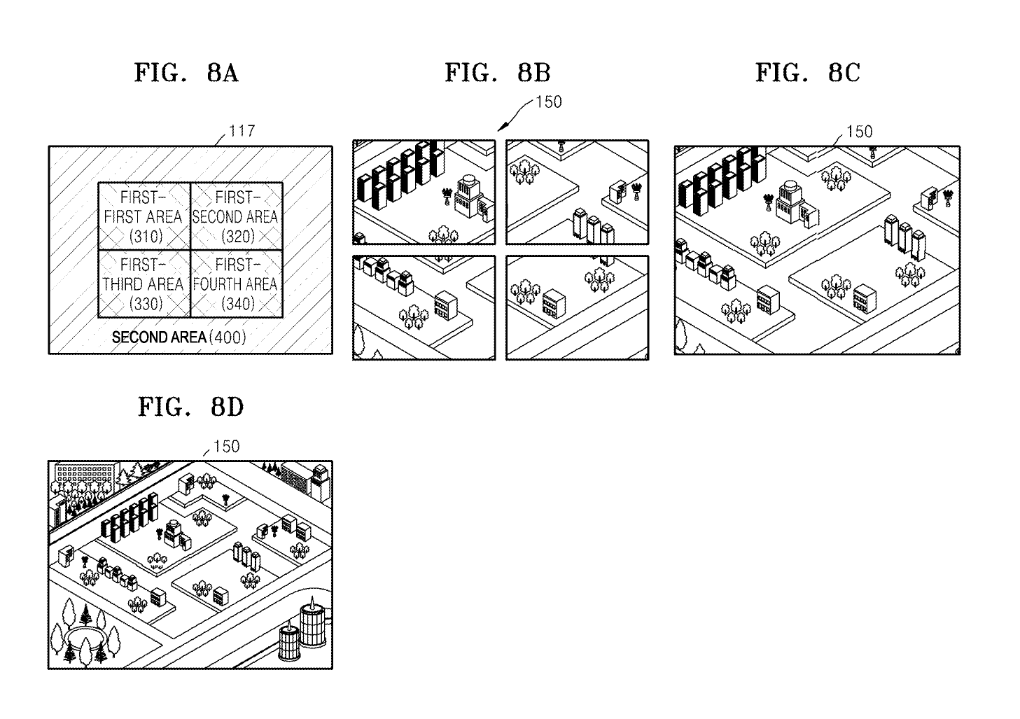

FIGS. 8A, 8B, 8C, and 8D are images displayed when the zoom-out function is performed. Referring to FIGS. 8A, 8B, 8C, and 8D, FIG. 8A shows an example in which the first area 300 of the image pickup device 117 is divided into a first-first area 310, a first-second area 320, a first-third area 330, and a first-fourth area 340.

FIG. 8B shows an example in which the controller 240 generates a first capture image from images in the first-first area 310, the first-second area 320, the first-third area 330, and the first-fourth area 340 and displays the first capture image on the display unit 150. In this case, the controller 240 may display all image data in the first-first area 310, the first-second area 320, the first-third area 330, and the first-fourth area 340 on the display unit 150, as shown in FIG. 8B. Alternatively, the controller 240 may sequentially display the image data in each of the first-first area 310, the first-second area 320, the first-third area 330, and the first-fourth area 340 on the display unit 150 one-by-one. Furthermore, the controller 240 may display an image corresponding to an area selected from among images in the first-first area 310, the first-second area 320, the first-third area 330, and the first-fourth area 340 on the display unit 150 in response to a user selection.

FIG. 8C shows an example in which the controller 240 combines all image data in the first-first area 310, the first-second area 320, the first-third area 330, and the first-fourth area 340 and displays the combined image data on the display unit 150.

FIG. 8D shows an example in which the controller 240 displays image data in the second area 400 including the first area 300 on the display unit 150 by the zoom key, a touch, or the setup menu input by the user.

Thereafter, in response to a capture signal input by the user, the controller 240 may generate a first capture image by capturing the first-first area 310, the first-second area 320, the first-third area 330, and the first-fourth area 340, generate a second capture image by capturing image data obtained by combining the first-first area 310, the first-second area 320, the first-third area 330, and the first-fourth area 340, or generate a third capture image by capturing image data including the combined image data and other image data outside the combined image data. Furthermore, the controller 240 may generate all of the first to third capture images in response to a single capture signal input by the user.

According to another embodiment, in a first selection and next display method, the controller 240 may receive from the image pickup device 117 a selection signal for one division area divided into the first-first area 310, the first-second area 320, the first-third area 330, and the first-fourth area 340, receive image data corresponding to the selected division area from the image pickup device 117, and display the image data on the display unit 150. In this case, the controller 240 may display image data corresponding to an area including the selected division area on the display unit 150 by the zoom key, a touch, or the setup menu input by the user.

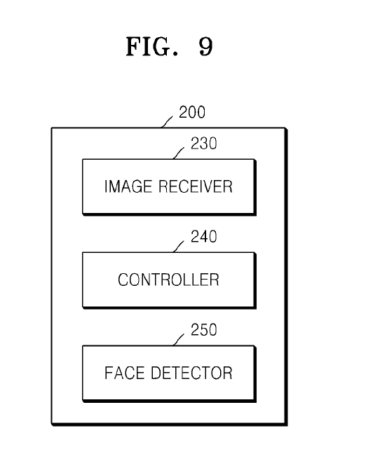

FIG. 9 is a detailed block diagram of the DSP 200, according to another embodiment. The DSP 200 includes an image receiver 230, the controller 240, and the face detector 250.

Compared with the embodiment shown in FIG. 2 in which the DSP 200 of FIG. 2 receives image data in the first area 300 and image data in the second area 400 from the image pickup device 117 and displays the image data on the display unit 150, the DSP 200 of FIG. 9 receives image data from the image pickup device 117 and then resizes image data in the first area 300 to a first image to display the first image on the display unit 150 or resizes image data in the second area 400 to a second image to display the second image on the display unit 150.

The image receiver 230 receives a picked-up image from the image pickup device 117. The image receiver 230 may receive image data, i.e., a picked-up image, projected to the second area 400 including the first area 300 and an area except for the first area 300 of the image pickup device 117. The second area 400 of the image pickup device 117 indicates an image data area including a valid pixel area (the first area 300) displayed on the display unit 150 and an area not displayed on the display unit 150 as an invalid pixel area but projected to the image pickup device 117.

The controller 240 resizes the picked-up image received from the image receiver 230 and displays the resized image on the display unit 150 as a first image. Thereafter, the controller 240 resizes the image data in the second area 400 including the first area 300 and an area except for the first area 300 in response to a zoom-out signal input by the user and displays the resized image data on the display unit 150 as a second image.

Thereafter, if a capture signal is input by the user, the controller 240 captures the resized second image to generate a capture image. Alternatively, when the capture signal is input by the user, the controller 240 may capture the resized first image to generate the capture image.

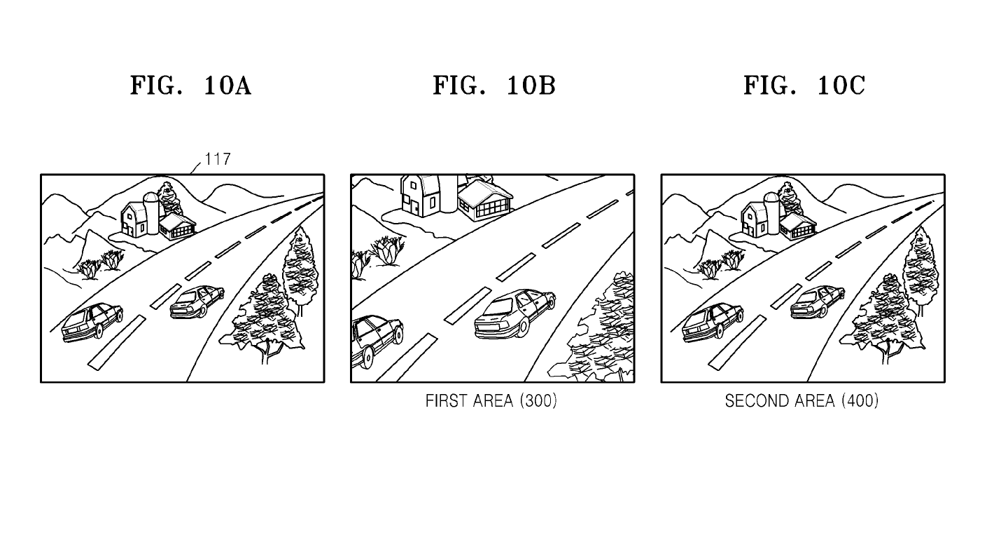

FIGS. 10A, 10B, and 10C are images displayed when the zoom-out function is performed by the DSP 200 of FIG. 9.

FIG. 10A shows image data in the first area 300 projected to the image pickup device 117 and the second area 400 including the first area 300.

FIG. 10B shows an example in which the controller 240 resizes image data corresponding to the first area 300 from among image data received from the image receiver 230 and displays the resized image data on the display unit 150 as a first image.

FIG. 10C shows an example in which the controller 240 resizes image data corresponding to the second area 400 from among the image data received from the image receiver 230 and displays the resized image data on the display unit 150 as a second image.

The controller 240 provides a zoom adjustment bar or a setup menu as described above so that the user can selectively view the image data in the first area 300 or the second area 400. A repeated description thereof is omitted herein.

When face detection is set on the setup menu, the controller 240 controls the face detector 250 to perform face detection on an image, resizes the image data in the first area 300 including a detected face, and displays the resized image data on the display unit 150 as a first image. If zoom-out is also set on the setup menu, the controller 240 resizes the image data in the second area 400 including the first area 300 in which the detected face is included and displays the resized image data on the display unit 150 as a second image. In this case, a current state can be switched to the default state or the zoom-in state using the zoom key.

In addition, the controller 240 may realize the zoom-out function by using a touch on the display unit 150 by the user and adjust a size of the second area 400 by receiving a size adjustment touch input by the user. A repeated description thereof is omitted herein.

According to another embodiment, the controller 240 may divide image data in the first area 300 received from the image receiver 230 into a plurality of pieces of image data in a plurality of division areas, resize the division images, and display the resized images on the display unit 150. When a capture signal is input by the user, the controller 240 may capture the plurality of division areas or a single area obtained by combining the plurality of division areas or may capture a second image including even image data outside a first image corresponding to the plurality of division images.

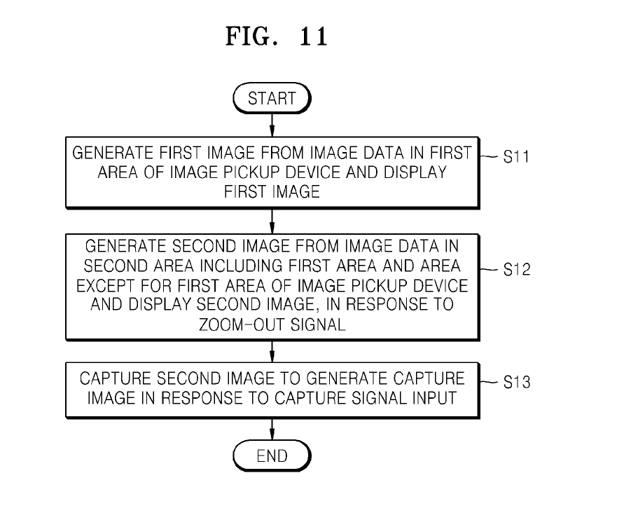

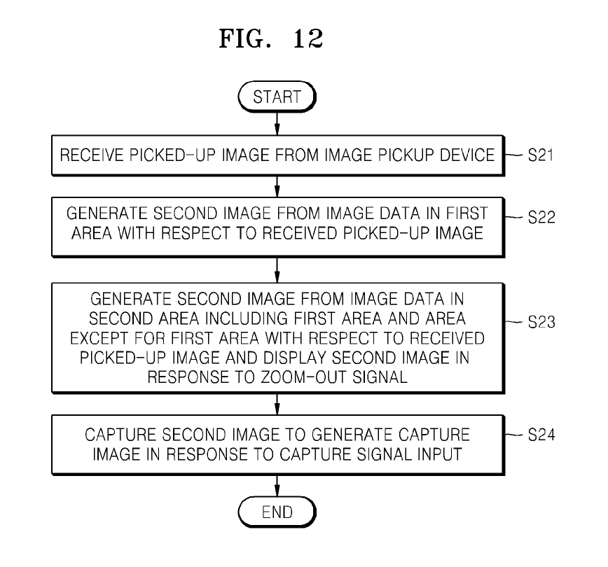

FIGS. 11 and 12 are flowcharts illustrating methods of controlling a digital photographing apparatus, according to various embodiments. The methods may be performed by the digital photographing apparatus shown in FIG. 1, and according to embodiments, a main algorithm of the methods may be performed by the DSP 200 with the help of other components in the digital photographing apparatus.

FIG. 11 is a flowchart illustrating a method of controlling the digital photographing apparatus, according to an embodiment. In the description below, a repeated part of the description of FIGS. 1 to 10C is not described.

In operation S11, the DSP 200 generates a first image from image data in the first area 300 of the image pickup device 117 and displays the first image on the display unit 150. If a capture signal is received in a state where the first image is displayed on the display unit 150, the DSP 200 may generate a capture image by capturing the first image.

If a zoom-out signal is received in a state where the first image is displayed on the display unit 150, the DSP 200 generates a second image from image data in the second area 400 including the first area 300 and an area except for the first area 300 of the image pickup device 117 and displays the second image on the display unit 150 in operation S12.

If a capture signal is received in a state where the second image is displayed on the display unit 150, the DSP 200 generates a capture image by capturing the second image in operation S13.

FIG. 12 is a flowchart illustrating a method of controlling the digital photographing apparatus, according to another embodiment. In the description below, a repeated part of the description of FIGS. 1 to 11 is not described.

In operation S21, the DSP 200 receives a picked-up image from the image pickup device 117. The picked-up image may be an image projected to the second area 400 including the first area 300 and an area except for the first area 300 of the image pickup device 117.

In operation S22, the DSP 200 resizes a first image from image data in the first area 300 with respect to the received picked-up image and displays the resized first image on the display unit 150. If a capture signal is received in a state where the resized first image is displayed on the display unit 150, the DSP 200 may generate a capture image by capturing the resized first image.

If a zoom-out signal is received in a state where the resized first image is displayed on the display unit 150, the DSP 200 resizes a second image from image data in the second area 400 including the first area 300 and an area except for the first area 300 of the image pickup device 117 with respect to the received picked-up image and displays the resized second image on the display unit 150 in operation S23.

If a capture signal is received in a state where the resized second image is displayed on the display unit 150, the DSP 200 generates a capture image by capturing the resized second image in operation S24.

As described above, according to the various embodiments, realizing a zoom-out function using an image area projected to an image pickup device may allow a user to capture images at various angles of view, thereby increasing user satisfaction when capturing an image.

The invention can also be embodied as computer-readable codes on a non-transitory computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, etc. The computer-readable recording medium can also be distributed over network-coupled computer systems so that the computer-readable code is stored and executed in a distributed fashion. Also, functional programs, codes, and code segments for accomplishing the invention can be easily construed by programmers skilled in the art to which the invention pertains. This computer readable recording media may be read by the computer, stored in the memory, and executed by the processor.

While the invention has been particularly shown and described with reference to exemplary embodiments thereof, it will be understood by those of ordinary skill in the art that various changes in form and details may be made therein without departing from the spirit and scope of the invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the invention.

All cited references including publicized documents, patent applications, and patents cited in the invention can be merged in the invention in the same manner as the shown by individually and concretely merging each cited reference and the shown by generally merging each cited reference in the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A method of controlling a digital photographing apparatus, the method comprising:
generating and displaying a first image from image data in a first area of an image pickup device; and
generating and displaying a second image from image data in a second area, which includes the first area and an area except for the first area of the image pickup device, in response to a zoom-out signal.

2. The method of claim 1, further comprising generating a capture image by capturing the second image in response to a capture signal.

3. The method of claim 1, further comprising generating a capture image by capturing the first image in response to a capture signal, after the generating and displaying of the first image.

4. The method of claim 1, wherein the generating and displaying of the first image comprises generating and displaying a plurality of first images from image data of a plurality of areas divided from the first area of the image pickup device or generating and displaying a single first image by combining the plurality of areas.

5. The method of claim 4, further comprising generating at least one of the first capture images obtained by capturing the plurality of divided areas and a second capture image obtained by capturing a single area obtained by combining the plurality of divided areas in response to a capture signal, after the generating and displaying of the first image.

6. The method of claim 1, wherein the generating and displaying of the second image comprises adjusting a size of the second area in response to the zoom-out signal.

7. The method of claim 1, wherein the generating and displaying of the second image comprises generating and displaying the second image in response to a first image touch signal.

8. The method of claim 1, wherein the generating and displaying of the second image comprises adjusting the size of the second area in response to a first image touch signal.

9. The method of claim 1, wherein the generating and displaying of the first image comprises generating and displaying a first image in which a face is included in the image data in the first area of the image pickup device.

10. A method of controlling a digital photographing apparatus, the method comprising:
receiving a picked-up image from an image pickup device;
generating and displaying a first image from image data in a first area of the received picked-up image; and
generating and displaying a second image from image data in a second area, which includes the first area and an area except for the first area of the received picked-up image, in response to a zoom-out signal.

11. The method of claim 10, further comprising generating a capture image by capturing the second image in response to a capture signal.

12. The method of claim 10, further comprising generating a capture image by capturing the first image in response to a capture signal, after the generating and displaying of the first image.

13. The method of claim 10, wherein the generating and displaying of the first image comprises generating and displaying a plurality of first images from image data of a plurality of areas divided from the first area of the image pickup device or generating and displaying a single first image by combining the plurality of areas.

14. The method of claim 13, further comprising generating at least one of the first capture images obtained by capturing the plurality of divided areas and a second capture image obtained by capturing a single area obtained by combining the plurality of divided areas in response to a capture signal, after the generating and displaying of the first image.

15. The method of claim 10, wherein the generating and displaying of the second image comprises adjusting a size of the second area in response to the zoom-out signal.

16. The method of claim 10, wherein the generating and displaying of the second image comprises generating and displaying the second image in response to a first image touch signal.

17. The method of claim 10, wherein the generating and displaying of the second image comprises adjusting the size of the second area in response to a first image touch signal.

18. The method of claim 10, wherein the generating and displaying of the first image comprises generating and displaying a first image in which a face is included in the image data in the first area of the image pickup device.

19. A digital photographing apparatus comprising:
a first receiver that receives image data of a first area of an image pickup device;
a second receiver that receives image data in a second area that includes the first area and an area except for the first area of the image pickup device; and
a controller that generates and displays a first image from the image data in the first area, which is received from the first receiver, and generates and displays a second image from the image data in the second area, which is received from the second receiver, in response to a zoom-out signal.

20. A digital photographing apparatus comprising:
a receiver that receives a picked-up image from an image pickup device; and
a controller that generates and displays a first image from image data in a first area of the received picked-up image and generates and displays a second image from image data in a second area, which includes the first area and an area except for the first area of the received picked-up image, in response to a zoom-out signal.
